(19) United States
(12) Patent Application Publication
(10) Pub. No.: US 2026/0168336 A1
(43) Pub. Date: Jun. 18, 2026

(54) PROTECTION FOR A PENETROMETER

(71) Applicant: FNV IP B.V., Leidschendam (NL)

(72) Inventors: Peter LOOIJEN, Leidschendam (NL); Verónica SUAREZ MENDEZ, Leidschendam (NL)

(73) Assignee: FNV IP B.V., Leidschendam (NL)

(21) Appl. No.: 19/128,762

(22) PCT Filed: Sep. 13, 2023
(86) PCT No.: PCT/EP2023/075118

§ 371 Date: May 9, 2025

(30) Foreign Application Priority Data
Nov. 14, 2022 (NL) 2033525

(51) Int. Cl. E21B 19/16; H01R 13/04

(52) U.S. Cl. CPC E21B 19/161; E21B 19/16; H01R 13/04

(57) ABSTRACT

Method and device for improved cone penetration testing, by providing a support casing for providing lateral support to a cone penetrometer assembly, an interlocking element for use in a support casing, a system for performing cone penetration tests, and a method of performing cone penetration testing. Unlocking insights from Geo-Data, the present invention further relates to improvements in sustainability and environmental developments: together we create a safe and liveable world.

### FIELD OF THE INVENTION

The present disclosure generally relates to a support casing for providing lateral support to a cone penetrometer assembly, and more particularly to an interlocking element for use in a support casing, a system for performing cone penetration tests, and a method of performing cone penetration tests. Unlocking insights from Geo-Data, the present invention further relates to improvements in sustainability and environmental developments: together we create a safe and liveable world.

### BACKGROUND OF THE INVENTION

There is a general and ongoing need to improve the quality and efficiency of subsurface testing to determine the characteristics of the soil at certain depths. Such subsurface characteristics may be soil type, density, moisture content, shear modulus, and the like, which may be used in foundation planning and/or management. Such soil characteristics may play a vital role in e.g., infrastructure projects, but may also be used to map soil characteristics for different purposes such as environmental projects, coastal resilience projects, or dam integrity projects. As an example, to determine what types of foundations are required for a particular building or infrastructure project, the soil types and their characteristics must be investigated.

One of the methods of performing such tests is known as a cone penetration test. The cone penetration or cone penetrometer test (CPT) is a geotechnical investigation method for determining soil and groundwater characteristics, wherein a cone penetrometer probe is pushed into the soil for measuring. Typical parameters measured by a probe are cone tip resistance, sleeve friction and pore-water pressure. Usually, the test method comprises pushing an instrumented cone penetrometer, with the tip facing down, into the ground at a controlled rate.

Known methods of performing such a CPT utilise a cone penetrometer assembly being built from a plurality of rod segments, forming a string of rods with a cone penetrometer positioned at the tip which is able to measure at the required depth. The rods are used to translate a pushing force to the cone penetrometer at the end of the string of rods. A cone penetrometer assembly thus refers to at least one rod and a cone penetrometer attached to an end of a first rod. A first rod segment is pushed into the ground by a hydraulic jack. A second rod segment is then positioned and connected to the first rod segment and the assembly is pushed further into the ground by the hydraulic jack. This process is repeated until the desired depth is reached or when the maximum push force is reached.

With increasing length of the rod, the pressure provided to the top segment to drive the rod into the soil generally becomes larger, leading to increased risks of instrument failure. Such failure may occur by sideways buckling of the rod. This problem generally occurs when the penetrometer assembly, particularly the rod, has insufficient lateral support in relation to the penetration force required to advance the penetrometer. For example, small deviations from a perfect vertical penetration direction may induce buckling and failure of the cone penetrometer assembly. This buckling predominantly occurs in the rod of the penetrometer assembly.

This problem is particularly relevant in cases where a soft layer of soil overlays a harder layer. In such cases, soft layer of soil does not provide sufficient lateral support to the penetrometer assembly to prevent buckling when the cone penetrometer reaches the hard layer underneath. Hard soils generally allow for higher penetration forces to be applied to the penetrometer due to the lateral pressure being applied to the penetrometer assembly. The hard soil thus provides support to the penetrometer assembly, as the assembly cannot easily move in an outward direction through displacement of the hard soil. On the other hand, a soft layer overlaying a hard layer does not provide such lateral pressure while still requiring a high penetration force to be applied to breach the hard layer underneath. As a result, particularly in such soil compositions, buckling of the cone penetrometer assembly, and especially the rod, is an ongoing problem.

Known solutions to limit buckling failures is to provide a casing to the penetrometer assembly, which is able to provide lateral support, which may lack in soft soils, to reduce the likelihood of buckling. Such a casing is provided in similar segments as the one or more rods of the cone penetrometer assembly and is provided as needed around the rod segments of the cone penetrometer assembly to provide additional lateral support to the penetrometer assembly. Such casing systems generally consist of pipe segments which are connected via threaded distal ends.

The provision of such casing systems is highly time-consuming and thus adds to operational costs. As a result, the casing systems are used less frequently, leading to increased risk of penetrometer failure, in particular rod failure, with high associated costs.

A recent advance in CPT systems has been made through the development of coiled CPT systems, in which the cone penetrometer assembly is not provided using a plurality of rod segments but rather consists of a continuous rod which is spooled in a coiled shape. The coiled CPT system thus mitigates the necessity of segmenting the penetrometer assembly into a plurality of rods, thus reducing operation time, and improving measurement results since the testing is no longer interrupted.

However, in such coiled CPT systems, the known casing systems cannot be provided since the pipe segments of the casing cannot be provided to the continuous coiled CPT system having a continuous rod as it is not a segmented system. As a result, coiled CPT systems can be used only where the risk of penetrometer buckling, particularly rod buckling, is relatively low. In other cases, due to a lack of lateral support in relation to the penetration force, the continuous rod of the coiled CPT system cannot be used at the desired depth.

The known state of the art for coiled CPT systems does not provide a solution for providing lateral support to the penetrometer assembly to prevent buckling failure.

There is thus a need for an improved support casing and methods for performing cone penetration tests.

### BRIEF SUMMARY OF THE INVENTION

According to one aspect of the present disclosure, there is provided a support casing for providing lateral support to a cone penetrometer assembly. The cone penetrometer assembly comprises a cone penetrometer and at least one cone penetrometer rod. In an advantageous embodiment, the cone penetrometer assembly may comprise an elongated rod, arranged to be used in coiled CPT systems. The cone penetrometer is attached to a distal end of the cone penetrometer rod to form the cone penetrometer assembly. The support casing of the present invention includes at least two interlocking elements, the at least two interlocking elements comprising a receiving section for at least partially receiving and containing a cone penetrometer assembly, and a locking mechanism, the locking mechanism being arranged to connect the at least two interlocking elements such that the at least two interlocking elements are laterally interlocked. That is, the interlocking elements may advantageously be laterally interlocked such that they do not allow for movement in the direction perpendicular to the axis of assembly.

In an embodiment, the receiving sections of the interlocking elements may be arranged to form a cylindrical casing space having a substantially circular lateral cross-section. The cylindrical casing space is arranged to laterally enclose around a cone penetrometer assembly at least partially as the cone penetrometer assembly is advanced into the soil. In an embodiment, the cylindrical casing space may be arranged to fully enclose around a cone penetrometer assembly as the cone penetrometer assembly is advanced into the soil. The cylindrical casing space may be arranged to laterally enclose at least partially around the cone penetrometer rod and/or the cone penetrometer provided at the distal end of the cone penetrometer rod. In an embodiment, the support casing may be provided to a cone penetrometer assembly comprising a single rod arranged to be used in a coiled CPT system and a cone penetrometer connected to a distal end of the rod. In another embodiment, the support casing may be provided to a cone penetrometer assembly comprising a plurality of cone penetrometer rods, connected to form an elongated cone penetrometer rod, and a cone penetrometer provided to a distal end of the first cone penetrometer rod. That is, the present disclosure provides a support casing which may advantageously be applied to coiled CPT systems but may also be applied to conventional segmented CPT systems requiring additional lateral support.

Advantageously, by providing the support casing according to the present invention, a coiled cone penetrometer assembly or a segmented cone penetrometer assembly can be provided with a casing to support the cone penetrometer assembly against lateral buckling. In particular, since the interlocking elements of the support casing are arranged to enclose the cone penetrometer assembly as it is being advanced into the soil during CPT, it does not need to be provided to the cone penetrometer assembly in segments. Known casing systems cannot be provided to coiled CPT systems since the pipe segments of the casing cannot be provided around to the elongated rod as it is a continuous system. The provision of the support casing of the present disclosure mitigates this issue by using the at least two interlocking elements to define a cylindrical casing space arranged to laterally enclose a cone penetrometer assembly.

As a result, coiled CPT systems can be used even in cases where the risk of penetrometer assembly buckling is relatively high, such as e.g., a soft region of soil overlaying a hard region of soil. The lateral support provided by the support casing to the penetrometer assembly limits the risk of buckling, in particular in regions where the soil itself does not provide sufficient lateral support to the cone penetrometer assembly to withstand the axial pressure provided thereto.

The at least two interlocking elements being laterally interlocked means that the interlocking elements cannot disengage from one another purely by lateral movement. Lateral in this context means substantially orthogonal to the lengthwise extension direction of the cone penetrometer assembly or the axial direction of the relevant component of the cone penetrometer assembly. As a result, when two or more interlocking elements are provided such that the cone penetrometer assembly is provided in the cylindrical casing space, accidental disengagement of the interlocking elements is prevented.

Disengagement of the interlocking elements may be achieved by e.g., sliding one interlocking element in an axial direction, relative to the other interlocking element, rotating one interlocking element relative to the other interlocking element or the cone penetrometer assembly, or by disengaging a clamp, screw, or the like. Once the interlocking elements are provided around the cone penetrometer assembly, the interlocking elements are kept in place by the locking mechanism to prevent accidental disengagement.

In an embodiment, the interlocking elements may comprise a metal material, advantageously steel. In an embodiment, the interlocking element may be coated with an abrasive-resistant coating, such as, but not limited to, ceramics, alumina ceramics, silicon carbide ceramics, zirconia ceramics, cast basalt, refractory cements, epoxy wearing compounds, abrasion resistant steels, tungsten carbides, thermal spray coatings, or the like. Alternatively, or additionally, the interlocking element is heat-treated, for example to increase the hardness of the material. In an embodiment, the interlocking element has a length in an axial direction between a top end and a bottom end of between about 2 cm and 40 cm, advantageously of between about 4 cm and 20 cm, more advantageously of between about 6 cm and 15 cm, still more advantageously of between 7 cm and 10 cm, still more advantageously of about 8 cm.

In an embodiment, the cylindrical casing space, defined by the receiving sections of at least two interlocking elements, defines an inner diameter of between about 10 mm and 150 mm, advantageously of between about 20 mm and 100 mm, more advantageously of between about 30 mm and 60 mm, still more advantageously of between about 40 mm and 50 mm.

In an embodiment, the at least two interlocking elements define, when interlocked, an outer diameter of between about 20 mm and 180 mm, advantageously of between about 40 mm and 140 mm, more advantageously of between 50 mm and 90 mm, still more advantageously of between about 60 mm and 80 mm.

In an embodiment, the at least two interlocking elements each define a semicylinder shape, such that two interlocking elements define the cylindrical casing space. In an embodiment, the interlocking element defines a semicylinder shape, such that the receiving section is arranged to enclose around one half of the cone penetrometer assembly. Alternatively, three or more interlocking elements may be provided to form the cylindrical casing space. For example, three interlocking elements may be provided such that advantageously each of the three interlocking elements define one third of a full cylinder in diameter. That is, three interlocking elements may define a complete circle to define a cylindrical casing space.

In such an embodiment, the three or more interlocking elements may be provided such that at least two of the three interlocking elements define a staggered pattern in an axial direction. The cylindrical casing space may be formed from multiple interlocking elements. Having two interlocking elements to laterally define the cylindrical casing space is most advantageous since the advantageous effects of the invention are achieved while minimizing the amount of interlocking parts, thus simplifying the assembly mechanism.

In an embodiment, the support casing comprises a first plurality of interlocking elements being provided in a first string and a second plurality of interlocking elements being provided in a second string. In the context of the present invention, a string is to be understood as at least two interlocking elements longitudinally connected. The interlocking elements provided in the first and second strings, are longitudinally connected to form the strings. The interlocking elements which are longitudinally connected to form a first and second strings may interlock with opposing interlocking elements. That is, an interlocking element provided in the first string, may interlock with an opposing interlocking element provided in the second string. The interlocking elements in the strings are thus longitudinally connected to form the strings and are arranged to laterally interlock with interlocking elements of an opposing string. In an embodiment, the support casing comprises at least two strings of interlocking elements. In an embodiment, the support casing comprises a first, a second, and a third string of interlocking elements. The interlocking elements provided in these three strings are longitudinally connected to form the strings and are arranged to laterally interlock to form a cylindrical casing space, arranged to engage with and around a CPT assembly.

Advantageously, the first and second strings can be formed by interlocking elements being positioned in an axial direction such that a top end of a first interlocking element is positioned below a bottom end of a second interlocking element. The first and second strings may comprise interlocking elements which are not physically connected and are held together only when they engage around a cone penetrometer assembly as it is advanced into the soil.

Advantageously, the first and second strings can be arranged to be provided around a cone penetrometer assembly as the cone penetrometer assembly is advanced into the soil such that the interlocking elements of the first string interlock with the interlocking elements of the second string.

By providing the interlocking elements on a first and a second string, the interlocking elements can engage with the cone penetrometer assembly as it is being advanced into the soil. The two strings are formed of axially positioned interlocking elements, i.e., above one another, the two strings advantageously being provided on either side of the cone penetrometer assembly as it is advanced into the soil. In an advantageous embodiment, the two strings may allow their interlocking elements to engage with one another in a zipper-like fashion, such that the support casing encloses from opposing sides from the advancing cone penetrometer assembly to form the cylindrical casing space around the penetrometer assembly.

In an embodiment, the first and/or second strings can be formed by interlocking elements being axially connected by a connection mechanism, wherein the connection mechanism attaches a top end of a first interlocking element to a bottom end of a second interlocking element to form the string.

The interlocking elements can advantageously be connected such that each string comprises a plurality of interlocking elements which are axially aligned. The connection mechanism between the top end of a first interlocking element and the bottom end of a second interlocking element may be any suitable connection mechanism. The connection mechanism may be provided by a flexible connection between the interlocking elements, such as e.g., a rubber or otherwise flexible seal between the top and bottom ends of two interlocking elements. The connection mechanism may also be provided by a mechanical connection, such as a pivot connection made with a pin. The connection mechanism may be provided by a nut and bolt, rivet, or other suitable fastening means.

In an embodiment, a top end of an interlocking element may comprise a protrusion having a through-hole oriented orthogonal to the direction of the cone penetrometer assembly and/or the axial extension of the receiving section. The bottom end of the interlocking element then comprises an aperture defined between two opposing protrusions, each having a similarly oriented through-hole, the aperture being arranged to receive the protrusion of the top end of the interlocking element. When the protrusion of the top end of a first interlocking element is provided in the aperture between the two protrusions of the bottom end of a second interlocking element, a pin can be advanced through the through holes of the protrusions, thus linking the top end and the bottom end of the interlocking elements together such that they allow for relative rotation between the two interlocking elements.

In an embodiment, the connection mechanism between the interlocking elements in a string can be formed such that only a single degree of freedom of movement is allowed between the interlocking elements. In an advantageous embodiment, the connection mechanism between the interlocking elements may only allow for relative rotation of an interlocking element relative to another interlocking element, the rotation being allowed around the connection mechanism. Advantageously the rotation is allowed such that a top end of the interlocking element can move away from the cone penetrometer assembly while the bottom end of the interlocking element remains in place. This way, the string is opened in a zipper-like fashion by rotation of the interlocking elements with respect to one another. Similarly, the rotation of the interlocking elements allows the closing of the strings in such a way that the cone penetrometer assembly is enclosed while it is advanced into the soil.

In an embodiment, the support casing may comprise three or more strings, each having a plurality of connected interlocking elements, wherein the interlocking elements are arranged to enclose the cone penetrometer assembly in its cylindrical casing space. In such an embodiment, the three or more strings similarly open and close, advantageously through the single-direction rotation between the interlocking elements. The three or more strings are then arranged to allow their interlocking elements to enclose around the cone penetrometer assembly.

In an embodiment, the support casing may further comprise a terminal element, the terminal element being connected to a terminal end of the first string and a terminal end of the second string, such that the terminal element connects the first string to the second string. Advantageously, the terminal element further comprises a connection mechanism which is arranged to connect the terminal element to the first and second strings.

By providing a terminal element, the first and second strings are connected to provide a connected starting point for the cone penetrometer assembly to engage with the strings. The terminal element thus aligns the first and the second string and makes the start procedure of the cone penetrometer testing more efficient.

According to an embodiment, the at least two interlocking elements can be arranged to interlock such that the interlocking elements define an axial offset with respect to each other. This is advantageously done such that a top section of a first of the at least two interlocking elements is arranged to engage with a bottom section of a second of the at least two interlocking elements.

By providing the interlocking elements such that they define an axial offset, each interlocking element interlocks with at least two other interlocking elements. This provides a sturdy arrangement since it takes away from the dependency of the structure on the axial connection mechanism of two interlocking elements in a string. If the interlocking elements do not define an axial offset with respect to one another, a pair of laterally opposed interlocking elements are only connected to one another, and not to further interlocking elements.

In such an event, tensional force on the support casing translates to the axial connection mechanism between the interlocking elements. As a result, the axial connection mechanism needs to be made much stronger to withstand such tensional forces. An offset between the interlocking elements provided in opposing strings reduces the axial load dependency of on the connection mechanism.

In an embodiment, the locking mechanism comprises at least one protrusion extending from the interlocking element, the protrusion being arranged to engage with an aperture of another interlocking element. In an embodiment, the at least one protrusion extending from the interlocking element comprises a stepped profile. Similarly, in such an embodiment, the aperture arranged to receive that protrusion also comprises a stepped profile. The stepped profile may advantageously define a height difference in the protrusion and the aperture when moving outward from the receiving section. As a result, two laterally interlocked elements cannot disengage with one another by sideways movement.

Two laterally opposed interlocking elements may be interlocked by the locking mechanism such that the protrusion from one interlocking element engages with an aperture in another interlocking element. In an embodiment, the protrusion may be positioned on an axially extending straight side, which is arranged to face an axially extending straight side of another interlocking element comprising an aperture. The protrusion of the locking mechanism may then engage with the aperture of the opposing interlocking element. In such an embodiment, some interlocking elements may only have apertures, while others have only protrusions.

In an embodiment, the locking mechanism further may comprise at least one aperture provided in the interlocking element, the aperture being arranged to receive a protrusion of another interlocking element. In such an embodiment, the locking mechanism comprises both a protrusion and an aperture arranged to receive another protrusion. This allows the interlocking elements to be produced homogeneously, without the need to produce e.g., male, and female versions. Advantageously, each interlocking element comprises a locking mechanism.

In an embodiment, the protrusion may extend outwardly in an upward direction towards a top end of the interlocking element, advantageously wherein the aperture extends inwardly in an upward direction towards a top end of another interlocking element.

By having the protrusion extend outwardly and in an upward direction towards a top end of the interlocking element, lateral displacement of the interlocking element is prevented when the locking mechanism interlocks the interlocking elements.

In an embodiment, the interlocking elements may be laterally interlocked to form a cylindrical casing space having a substantially circular lateral cross-section. Accordingly, the cylindrical casing space is hollow to allow the placing of the penetrometer within the cylindrical casing space.

According to an aspect of the present disclosure, there is provided an interlocking element for use in a support casing according to any of the embodiments disclosed herein, the interlocking element comprising a receiving section for at least partially receiving and containing a cone penetrometer assembly, and a locking mechanism, the locking mechanism being arranged to laterally interlock the interlocking element to another interlocking element.

Advantageously, the receiving section of the interlocking element is arranged to form a part of a cylindrical casing space having a substantially circular lateral cross-section. In an embodiment, the cylindrical casing space may be arranged to laterally enclose around a cone penetrometer assembly as the cone penetrometer assembly is advanced into the soil.

In an embodiment, the interlocking element may define a semicylinder shape, such that the receiving section is arranged to enclose around one half of the cone penetrometer assembly. In an additional or alternative embodiment, the locking mechanism may comprise at least one protrusion extending from the interlocking element, the protrusion being arranged to engage with an aperture of another interlocking element. In an embodiment, the protrusion may extend outwardly from the interlocking element in an upward direction to a top end of the interlocking element.

In an embodiment, the interlocking element may further comprise an aperture arranged to receive a protrusion extending from another interlocking element.

According to an aspect of the present disclosure, there is provided a system for performing cone penetration tests, comprising: a cone penetrometer assembly comprising an elongated cone penetrometer rod and a cone penetrometer connected to a distal end of the elongated cone penetrometer rod, the cone penetrometer rod being spooled in a substantially circular shape; a bending device arranged to straighten or bend the cone penetrometer rod, the bending device being arranged such that the cone penetrometer rod is deformed from its substantially circular shape into a substantially straight shape, and from a substantially straight shape into a substantially circular shape and such that the cone penetrometer assembly is provided above the soil to be penetrated; a first casing guide and a second casing guide, the first and second casing guides being positioned on opposing sides of the cone penetrometer assembly; a first plurality of interlocking members according to any of the embodiments disclosed herein, provided in a first string over the first casing guide; and a second plurality of interlocking members according to any of the embodiments disclosed herein provided in a second string over the second casing guide. Advantageously, the first and second plurality of interlocking members are arranged to interlock to encase the cone penetrometer assembly as the cone penetrometer assembly is advanced into the soil.

In an embodiment, the first and/or second casing guide may be a first and/or second casing drum, such that the strings of interlocking members are provided around the casing drums.

In an embodiment, the system may further comprise a drive system arranged to provide a penetration force to the cone penetrometer assembly and/or the support casing. Advantageously, the cone penetration force is between about 1 and 40 tonnes, more advantageously between about 5 and 35 tonnes, still more advantageously between about 15 and 25 tonnes. Advantageously, the drive system is arranged to advance the cone penetrometer assembly at a constant speed in a continuous manner.

The drive system may be arranged to clamp the cone penetrometer assembly with a first and second clamp positioned below the first clamp. The first clamp may engage with the cone penetrometer rod to drive the assembly into the ground by moving in a downward direction. Once a terminal position of the first clamp is reached, the second clamp engages with the rod, and the first clamp disengages with the rod. Then, the first clamp is moved in an upward direction in a disengaged state, while the second clamp is moved in a downward direction while being engaged with the rod. Once a terminal position of the second clamp is reached, the second clamp may be disengaged, the first clamp may engage with the rod, and the process may be repeated. Alternatively, one of the clamps may be static, such that it engages with the rod while the other clamp is disengaged while it moves in an upward direction before it reengages with the rod. Other drive systems may be similarly applied to the system for performing cone penetration tests.

In an embodiment, the drive system may be arranged to drive the cone penetrometer assembly into the ground, separately from the support casing. A separate casing drive system may be provided to drive the support casing into the soil separately from or simultaneous with the cone penetrometer assembly. The casing drive system may operate in a similar manner to the drive system for the cone penetrometer assembly. In such an embodiment, the bending device is provided above the drive system, so that the cone penetrometer rod is straightened when handled by the drive system. Below the drive system, the first and/or second casing guides are positioned, on opposing sides of the cone penetrometer assembly. Below the casing guides, the casing drive system is provided, which is arranged to engage with the support casing once its interlocking elements are engaged with one another to enclose the cone penetrometer assembly.

According to an aspect of the present disclosure, there is provided a method of performing cone penetration testing, the method comprising the steps of: providing a coiled cone penetrometer assembly being spooled in a substantially circular shape; providing a support casing according to any of the embodiments disclosed herein; advancing the cone penetrometer assembly into the soil; and simultaneously enclosing the casing around the cone penetrometer assembly as the cone penetrometer assembly is advanced into the soil.

In an embodiment, the cone penetrometer assembly may be advanced into the soil first without the support casing. Once a determination is made that a risk of buckling has emerged, the cone penetrometer assembly is retracted from the soil. The support casing is then applied to the cone penetrometer assembly as it is advanced into the soil again.

In an embodiment, the cone penetrometer assembly may be advanced into the soil together with the support casing. A drive system may be provided to drive the cone penetrometer assembly and the support casing. Alternatively, a drive system may be provided for the cone penetrometer and a drive system may be provided for the support casing. These systems may operate similarly.

In an embodiment, the cone penetrometer assembly may be advanced together with the support casing until a predetermined point. After the predetermined point, the cone penetrometer assembly may advance further into the soil while the support casing remains in place. In an embodiment, the predetermined point may be a depth into the soil where the soil is harder than the soil overlying the hard section of soil. In such an embodiment, the cone penetrometer assembly is supported by the support casing in the soft section of soil, while below the soft section, the lateral support is provided by the hard soil itself.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. A reference to an embodiment in the present disclosure can be a reference to the same embodiment or any other embodiment. Such references thus relate to at least one of the embodiments herein.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are therefore not to be considered to be limiting of its scope, the principles herein are described and explained with additional specificity and detail through the use of the accompanying drawings in which:

FIG. 1 is a side view of one embodiment of the invention showing the support casing in a partly opened position;

FIG. 2 is a side view of one embodiment of the invention showing the support casing in a closed position;

FIG. 3 is a cross-sectional view of one embodiment of the invention showing the support casing in a partly opened position around a cone penetrometer assembly;

FIG. 4 shows a three-dimensional view of one embodiment of the invention showing an interlocking element;

FIG. 5 shows a three-dimensional view of one embodiment of the invention showing an interlocking element;

FIG. 6 shows a three-dimensional view of one embodiment of the invention showing a terminal element; and

FIG. 7 shows a side view of one embodiment of the invention showing a system for performing cone penetration tests.

### DESCRIPTION OF ILLUSTRATIVE EMBODIMENTS

The following is a description of certain embodiments of the invention, given by way of example only and with reference to the drawings.

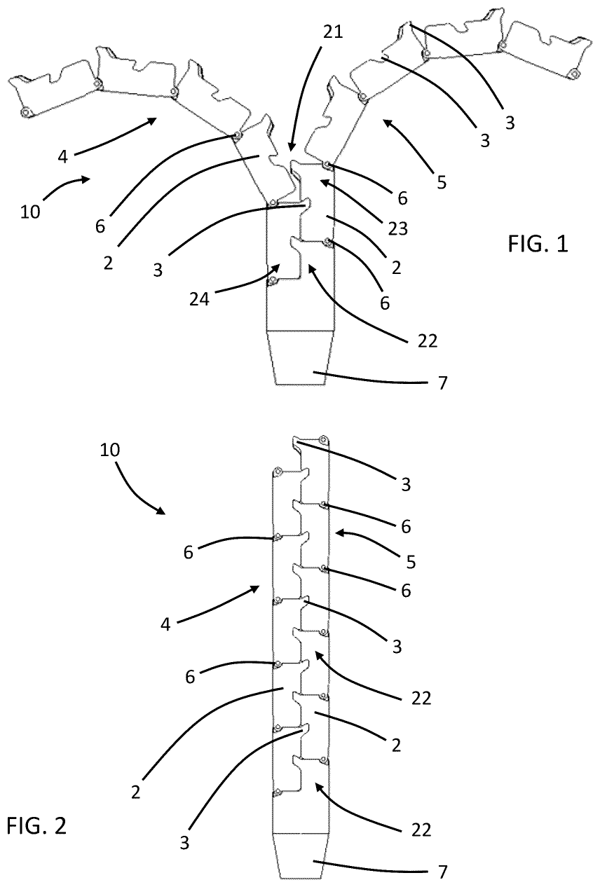

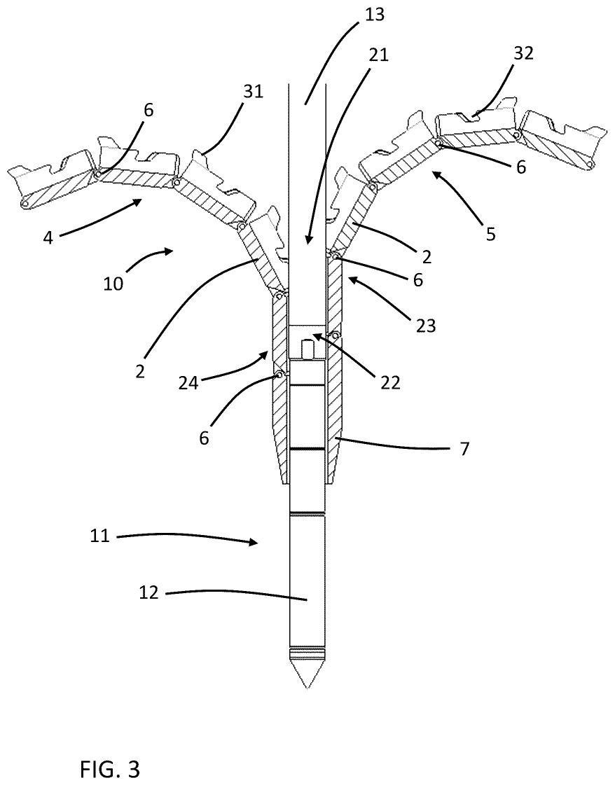

Referring to FIG. 1, a side view of the support casing 10 is shown. The support casing comprises a plurality of interlocking elements 2. The interlocking elements 2 are positioned such that two opposing interlocking elements 2 form a cylindrical casing space 22 arranged to laterally enclose around a cone penetrometer assembly 11, shown in FIG. 3. The interlocking elements 2 comprise a receiving section 21 which is arranged to receive and contain a cone penetrometer assembly at least partially.

The receiving sections 21 form, when the interlocking elements 2 are laterally interlocked, the cylindrical casing space 22 which is arranged to contain the cone penetrometer assembly 11. The shown embodiment of the invention comprises two strings of interlocking elements. A first string 4 is shown on the left and a second string 5 is shown on the right. The first 4 and second 5 strings are composed of a plurality of interlocking elements 2 which are connected to one another via the connection mechanism 6.

The connection mechanism 6 allows for relative rotation between the interlocking elements 2 in a direction away from the axial direction of the cone penetrometer assembly 11 such that the first 4 and second 5 strings open to allow a cone penetrometer assembly 11 to be positioned in the cylindrical casing space 22 formed by the receiving sections 21 of the interlocking elements 2. The first 4 and second 5 strings interlock in a zipper-like fashion to form an enclosed casing around the cone penetrometer assembly 11.

The interlocking elements 2 of the support casing 10 comprise a locking mechanism 3 to interlock the interlocking elements 2 to one another. Specifically, the locking mechanism 3 is arranged to interlock the interlocking elements 2 which are laterally opposed to one another. As shown, the interlocking elements 2 are engaged to one another in such a manner that they cannot be laterally removed without rotation relative to one another. As such, when the interlocking elements 2 are interlocked then can only be unlocked from one another by rotating the top interlocking element 2 which is engaged with an opposing interlocking element 2.

Now referring to FIG. 2, a side view is shown of the support casing 10 in a closed configuration. As shown, the locking mechanism 3 interlocks the interlocking elements in such a manner that they cannot be removed by only lateral movement. Due to the connection mechanism 6, the rotation of the interlocking elements 2 with respect to one another allows the interlocking elements 2 to be unlocked.

In the shown embodiment, the interlocking elements 2 are arranged to interlock such that the interlocking elements 2 define an axial offset with respect to each other. As such, a top section 23 of a first interlocking element 2 is arranged to engage with a bottom section 24 of another interlocking element 2. As a result, each interlocking member 2 engages with two other interlocking members 2, which increases the structural integrity of the support casing 10.

Now referring to FIG. 3, a cross-sectional view of the support casing 10 according to an embodiment of the invention is shown. The support casing 10 is provided around a cone penetrometer assembly 11, comprising a cone penetrometer 12 and a rod 13, advantageously an elongated rod. which is provided in the cylindrical casing space 22 formed by the receiving sections 21 of the interlocking elements 2.

As shown, the cone penetrometer assembly 11 is arranged to extend through the terminal element 7 of the support casing 10. This ensures that the sensors in the cone penetrometer 12 can still measure the appropriate soil characteristics, while the rod 13 is supported by the support casing.

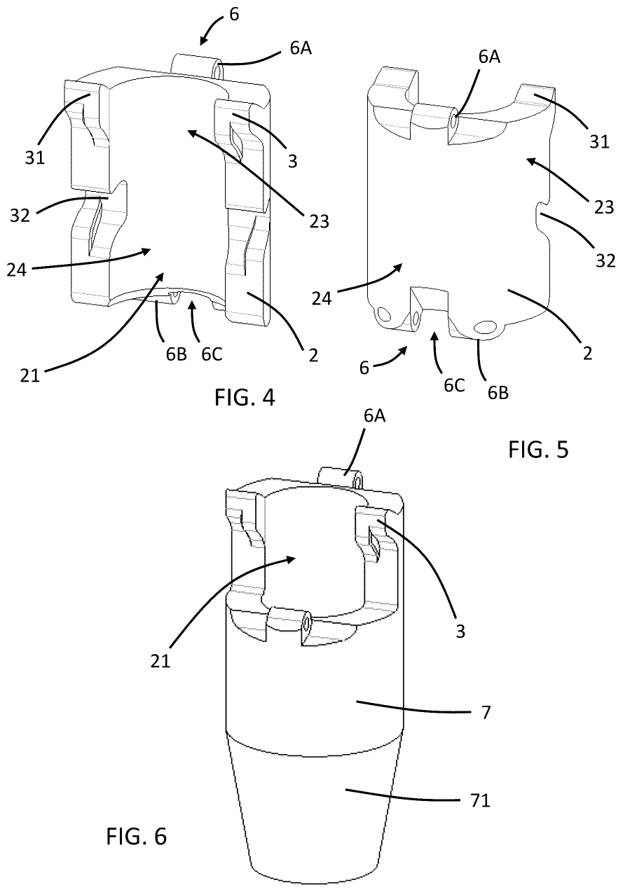

Now referring to FIG. 4 and FIG. 5, a three-dimensional view of an embodiment of the interlocking element 2 is shown. The interlocking element 2 comprises a connection 6 comprising a protrusion 6A with a through-hole at the top of the interlocking element 2 and an aperture 6C between two further protrusions 6B with through-holes at the bottom of the interlocking element 2. This configuration may also be reversed, with the aperture being positioned at the top of the interlocking element 2.

The locking mechanism 3 of the interlocking element 2 comprises two protrusions 31 positioned at a top section 23 of the interlocking element 2 and two apertures 32 positioned at a bottom section 24 of the interlocking element 2. The protrusions 31 of the interlocking element 2 are arranged to engage with the apertures 32 of another interlocking element 2 to laterally interlock the elements 2 such that they form a cylindrical casing space 22 to laterally support a cone penetrometer assembly 11.

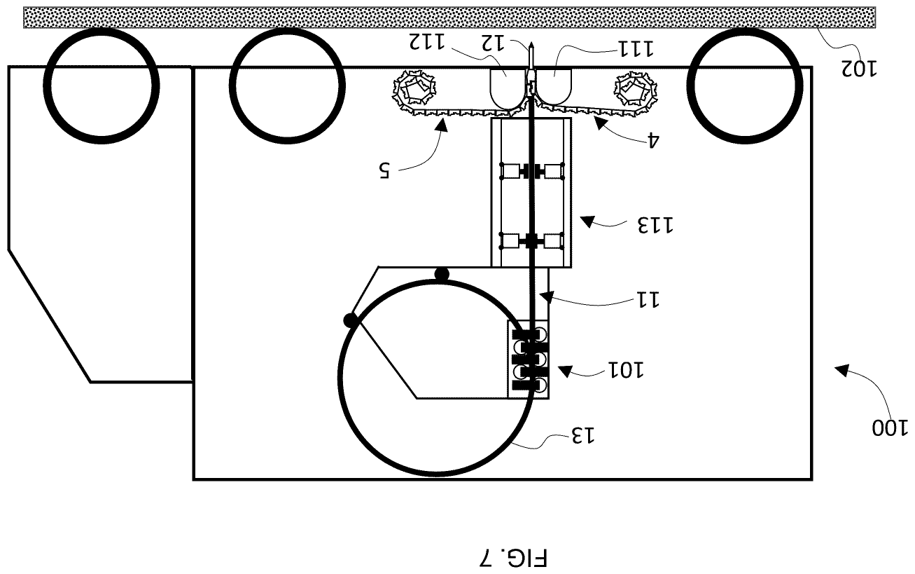

Now referring to FIG. 6, a three dimensional view of a terminal element 7 according to an embodiment of the invention is shown. The terminal element 7 is arranged to be connected to a terminal end of the first string 4 and a terminal end of the second string 5, such that the terminal element 7 connects the first string 4 to the second string 5. The terminal element 7 comprises a connection mechanism 6 to connect to the interlocking elements 2 of the first 4 and second 5 strings. The terminal element 7 further comprises a tapered section 71. The tapered section 71 of the terminal element 7 advantageously reduces friction as the support casing 10 is advanced into the soil.

Now referring to FIG. 7, a system 100 for performing cone penetration tests is shown. The system comprises a cone penetrometer assembly 11 comprising an elongated cone penetrometer rod 13 and a cone penetrometer 12 connected to a distal end of the elongated cone penetrometer rod 13. The cone penetrometer rod 13 is spooled in a substantially circular shape.

The system further comprises a bending device 101 arranged to straighten or bend the cone penetrometer rod 13. The bending device 101 is arranged such that the cone penetrometer rod 13 is deformed from its substantially circular shape into a substantially straight shape or from a substantially straight shape into a substantially circular shape. The cone penetrometer assembly 11 is provided above the soil 102 to be penetrated.

The system further comprises a first casing guide 111 and a second casing guide 112. The first 111 and second 112 casing guides are positioned on opposing sides of the cone penetrometer assembly 11.

The system further comprises a first plurality of interlocking members according to any of the embodiments disclosed herein, which are provided in a first string 4 over the first casing guide 112 and a second plurality of interlocking members according to any of the embodiments disclosed herein, which are provided in a second string 5 over the second casing guide 112.

The first and second plurality of interlocking members are arranged to interlock to encase the cone penetrometer assembly 11 as the cone penetrometer assembly 11 is advanced into the soil 102. A drive system 113 may be provided to drive the cone penetrometer assembly and the support casing.

The invention has been described by reference to certain embodiments discussed above. It will be recognized that these embodiments are susceptible to various modifications and alternative forms well known to those of skill in the art.

Further modifications in addition to those described above may be made to the structures and techniques described herein without departing from the spirit and scope of the invention. Accordingly, although specific embodiments have been described, these are examples only and are not limiting upon the scope of the invention.

1. A support casing for providing lateral support to a cone penetrometer assembly, the support casing comprising:
at least two interlocking elements, the at least two interlocking elements comprising:
a receiving section for at least partially receiving and containing the cone penetrometer assembly, and
a locking mechanism, the locking mechanism being arranged to connect the at least two interlocking elements such that the at least two interlocking elements are laterally interlocked,
wherein the receiving sections of the at least two interlocking elements are arranged to form a cylindrical casing space having a substantially circular lateral cross-section, the cylindrical casing space being arranged to laterally enclose around the cone penetrometer assembly as the cone penetrometer assembly is advanced into the a soil.

2. The support casing according to claim 1, wherein the at least two interlocking elements each define a semicylinder shape, such that two interlocking elements define the cylindrical casing space.

3. The support casing according to claim 1, the support casing comprises a first plurality of interlocking elements being provided in a first string and a second plurality of interlocking elements being provided in a second string,
the first string and the second strings being formed, respectively, by the first plurality of interlocking elements and the second plurality of interlocking elements being positioned in an axial direction such that a top end of a first interlocking element is positioned below a bottom end of a second interlocking element,
wherein the first string and the second strings are arranged to be provided around the cone penetrometer assembly as the cone penetrometer assembly is advanced into the soil such that the first interlocking elements of the first string with the second interlocking elements of the second string.

4. The support casing according to claim 3, wherein the first string and/or the second strings are formed by the at least two interlocking elements being axially connected by a connection mechanism, wherein the connection mechanism attaches the top end of the first interlocking element to the bottom end of the second interlocking element to form the first string and the second string.

5. The support casing according to claim 3, further comprising a terminal element the terminal element being connected to a terminal end of the first string and a terminal end of the second string such that the terminal element connects the first string to the second string.

6. The support casing according to claim 1, wherein the at least two interlocking elements are arranged to interlock such that the at least two interlocking elements define an axial offset with respect to each other, such that a top section of a first of the at least two interlocking elements is arranged to engage with a bottom section of a second of the at least two interlocking elements.

7. The support casing according to claim 1, wherein the locking mechanism comprises at least one protrusion extending from at least one of the at least two interlocking elements the at least one protrusion being arranged to engage with an aperture of another interlocking element.

8. The support casing according to claim 7, wherein the locking mechanism further comprises at least one aperture provided in the interlocking element, the aperture being arranged to receive a protrusion of the another interlocking element.

9. The support casing according to claim 7, wherein the at least one protrusion extends outwardly in an upward direction towards a top end of the interlocking element.

10. The support casing according to claim 1, wherein the at least two interlocking elements are laterally interlocked to form a cylindrical casing space having a substantially circular lateral cross-section.

11. An interlocking element for use in a support casing the interlocking element comprising:
a receiving section for at least partially receiving and containing a cone penetrometer assembly, and
a locking mechanism, the locking mechanism being arranged to laterally interlock the interlocking element to another interlocking element,
wherein the receiving section of the interlocking element is arranged to form a part of a cylindrical casing space having a substantially circular lateral cross-section, the cylindrical casing space being arranged to laterally enclose around a cone penetrometer assembly as the cone penetrometer assembly is advanced into a soil.

12. The interlocking element according to claim 11, wherein the interlocking element defines a semicylinder shape, such that the receiving section is arranged to enclose around one half of the cone penetrometer assembly.

13. The interlocking element according to claim 11, wherein the locking mechanism comprises at least one protrusion extending from the interlocking element the protrusion being arranged to engage with an aperture of another interlocking element.

14. (canceled)

15. A method of performing cone penetration tests, the method comprising the steps of:
providing a cone penetrometer assembly comprising an elongated cone penetrometer rod and a cone penetrometer connected to a distal end of the elongated cone penetrometer rod, the cone penetrometer rod being spooled in a substantially circular shape;
providing support casing including at least two interlocking elements, the at least two interlocking elements including:
a receiving section for at least partially receiving and containing the cone penetrometer assembly, and
a locking mechanism, the locking mechanism being arranged to connect the at least two interlocking elements such that the at least two interlocking elements are laterally interlocked,
wherein the receiving section of the at least two interlocking elements are arranged to form a cylindrical casing space having a substantially circular lateral cross-section, the cylindrical casing space being arranged to laterally enclose around the cone penetrometer assembly as the cone penetrometer assembly is advanced into a soil;
advancing the cone penetrometer assembly into a soil; and
simultaneously enclosing the casing around the cone penetrometer assembly as the cone penetrometer assembly is advanced into the soil.

16. The method according to claim 15, wherein the at least two interlocking elements each define a semicylinder shape, such that two interlocking elements define the cylindrical casing space.

17. The method according to claim 15, the support casing comprises a first plurality of interlocking elements being provided in a first string and a second plurality of interlocking elements being provided in a second string,
the first string and the second string being formed, respectively, by the first plurality of interlocking elements and the second plurality of interlocking elements being positioned in an axial direction such that a top end of a first interlocking element is positioned below a bottom end of a second interlocking element,
wherein the first string and the second string are arranged to be provided around the cone penetrometer assembly as the cone penetrometer assembly is advanced into the soil such that the first interlocking element of the first string with the second interlocking element of the second string.

18. The method according to claim 17, wherein the first string and/or the second string are formed by the at least two interlocking elements being axially connected by a connection mechanism, wherein the connection mechanism attaches the top end of the first interlocking element to the bottom end of the second interlocking element to form the first string and the second string.

19. The method according to claim 17, further comprising a terminal element, the terminal element being connected to a terminal end of the first string and a terminal end of the second string, such that the terminal element connects the first string to the second string.

20. The method according to claim 15, wherein the at least two interlocking elements are arranged to interlock such that the at least two interlocking elements define an axial offset with respect to each other, such that a top section of a first of the at least two interlocking elements is arranged to engage with a bottom section of a second of the at least two interlocking elements.

21. The method according to claim 15, wherein the locking mechanism comprises at least one protrusion extending from at least one of the at least two interlocking elements, the at least one protrusion being arranged to engage with an aperture of another interlocking element.
